(19) United States
(12) Patent Application Publication
(10) Pub. No.: US 2017/0143124 A1
(43) Pub. Date: May 25, 2017

(54) Hygienic Headrest Cover

(71) Applicant: Thomas Pierce, Miami, FL (US)

(72) Inventor: Thomas Pierce, Miami, FL (US)

(21) Appl. No.: 15/357,292

(22) Filed: Nov. 21, 2016

Related U.S. Application Data
(60) Provisional application No. 62/258,157, filed on Nov. 20, 2015.

(51) Int. Cl. A47C 7/62; B60N 2/48; B60N 2/60

(52) U.S. Cl. CPC A47C 7/386; B60N 2/6063; B60N 2/48

(57) ABSTRACT

In a cover for a variable geometry vehicle headrest having a geometry including a center surface and integral left and right lateral extensions, each of the lateral extensions defining planes of angulation relative to the center surface along respective lines of dependency between the center surface and each respective lateral extension, the cover includes a stretchable, breathable moisture-absorbent fabric enveloping the headrest and formed in proportion to dimensions smaller that the headrest but within a range of stretchability of the cover relative to the dimensions the headrest, the fabric including internal bands of resilient material having a greater modulus of elasticity than that of the fabric, the bands secured within the fabric proximally against each of the lines of dependency between the center surface and the lateral extensions of the headrest.

### REFERENCE TO RELATED APPLICATION

This application claims the benefit under 35 USC 119(e) of provisional patent application Ser. No. 62/258,157, filed Nov. 20, 2015, which is incorporated by reference in its entirety.

### BACKGROUND OF THE INVENTION

1. Field of the Invention

The present invention relates to hygienic headrest covers for headrests of vehicles inclusive of airplanes, cinema seats, automobiles, buses, trains and boats, in which the headrest exhibits an adjustable geometry.

2. Description of the Related Art

For purposes of illustration, most references made herein are to the use of headrest covers on airline carriers and cinema seats, but the invention applies to all forms of transportation, public conveyances, and facilities in both commercial and residential settings, i.e., buses, trains, boats, automobiles, medical/dental facilities, entertainment venues, offices, homes and the likes. The present invention finds utility anywhere an individual might find it necessary to use a seat that has been previously occupied by other individuals.

Ever since the introduction of the headrest portion of a seat on transportation vehicle seats, and more recently on cinema theaters, the issue of the headrest becoming soiled and potentially contaminated by constant contact with multiple occupants has been a concern to respective industries, health agencies, and the informed general public. This concern is especially acute on long transit transportation and cinema theaters where the seat occupants constantly rub their scalps against the headrest while assuming a more relaxed position. Such continuous contact with the headrest results in it quickly becoming soiled, creating a potentially unsanitary surface, which may act as a conduit to transfer contaminants to subsequent occupants.

High traffic surfaces harbor microorganisms that can contaminate a multitude of people. The present invention is designed not only to prevent possible soiling of the head-rest portion of a seat, but also the possibility of transmission of scalp, skin, parasitic and other diseases from any of the many previous users of the seat to another user. This possibility of transmission increases due to the fact that most people, in many high traffic and crowded settings, use the headrest portion of seats as handle bars. They are used as leverage to get in, out and up from seats, as balancing tools while moving down the isle or simply as a place to set ones hands while standing, chatting, or waiting to disembark.

Throughout the useful life of commercial airplanes and cinema theaters, seats can often be occupied by thousands of different individuals of various degrees of cleanliness and health conditions before seats are ever cleaned, replaced, or reupholstered. In many cases, the cleaning process might not sufficiently sanitize the headrest. Most health agencies cite international travel as a major factor in the global spread of contagious diseases. If headrest surfaces are not consistently cleaned after each occupant, the seats can potentially expose a multitude of future occupants to serious health hazards which could later be transferred and spread across entire communities.

Resting one's head on the headrest of an unprotected public seat could be the equivalent of resting ones head on a hotel pillow that has been used by multiple individuals, without changing the pillow casing. No one well informed of the potential risk and consequences would willingly rub their head against a stranger's scalp, much less with that of the hundreds of individuals with different degrees of hygiene and unknown health conditions that have used the seat before them. For these reasons alone, it might be concluded that in an effort to reduce or control the effects of a potential pandemic, public conveyances and entertainment venues might appropriately be required to provide sanitized covers after each leg of travel and prior to every show-time, respectively. If such a mandate were to be imposed today, many public carriers would be under prepared to comply with such a directive. Many transportation carriers would not be able to absorb the time and financial burden required in complying with such a legal requirement, and those industries that did, would likely pass the incremental cost directly onto the customers.

The airline industry and other agencies have long sought alternative means for efficiently addressing said problems without imposing further stress on an industry already under economic pressures. One reason airlines do not provide protective covers to passengers is the fact that most, if not all presently available headrest covers, are too costly to provide. They require extensive handling and are considered invasive to the seat, often requiring attachment elements to be previously and/or permanently embedded onto the seats.

An even more deterrent factor materializes with the use of presently available reusable headrest covers. The reusable versions of headrest covers are primarily made of cloth, leather, or towel like material. The laundering of such covers is an expensive operation, requiring additional handling for packaging and transporting it to and from the processing locations. The life time replacement cycle for reusable covers primarily depends on how often they are cleaned, as the laundering process deteriorates the fabric, its texture, and its colors.

In summary, a number of issues presently face carriers when using any of the currently available headrest covers and it becomes apparent that these issues are major deterrents to the consistent use of headrest covers. These issues include: the cost to purchase; the cost to incorporate required engagement elements onto existing and new seats; the labor cost required to implement a one cover per passenger cycle; the cost of replacing all covers after each individual use; the cost of discarding fresh covers, not being able to distinguish the used from the new covers; the cost of shipping, laundering, storing and handling of reusable covers; the cost associated with potential delays to flight schedules contribute an unnecessary burden on industries already in distress.

The above harmful impact to use frequency for headrest covers therefore obscures a cover's ultimate function: to protect individuals and communities from potential contamination. In addition to protection, the use of headrest covers provides the concerned public with an added advantage; namely, user peace of mind. Once again in summary, all reusable and disposable replaceable headrest covers previously developed, suffer from a number of critical disadvantages that hinder the consistent use of said covers.

Research indicates that one convenient solution for such a critical and global dilemma would be to make available to applicable industries and the general public, an economical, replaceable, compact, disposable headrest cover that can be installed and removed easily and disposed of by the seat occupants themselves. If the travel community and general public have not yet publicly raised concerns, it is mainly because they are uninformed about such facts.

To minimize the potential for transmission of any virus, skin condition, or communicable diseases, the headrest cover should be available on a consistent basis. International carriers can be a major factor in the spread of a disease globally. Getting ill while aboard an airplane is a serious matter. From the common cold to more serious infections, air passengers are more exposed to germs and viruses than ever before. High traffic surfaces harbor microorganisms that can contaminate a multitude of people. The present invention is designed not only to protect against soiling of the head-rest portion of the seat, but also the possibility of transmission of scalp, skin and other diseases from any prior user of the seat to others.

Representative prior art in patents is reflected in U.S. Pat. No. 3,654,059 (1972) to Zisblatt; U.S. Pat. No. 7,726,735 (2010) to Resendiz; and U.S. Pat. No. 8,191,969 (2012) to Dermaris.

### SUMMARY OF THE INVENTION

In a cover for a variable geometry vehicle headrest having a geometry includes a center surface and integral left and right lateral extensions, each of said lateral extension defining planes of angulation relative to said center surface along respective lines of dependency between said center surface and each respective lateral extension, the cover comprising, the cover comprises a stretchable, breathable moisture-absorbent fabric enveloping said headrest and formed in proportion to dimensions smaller that said headrest but within a range of stretchability of the cover relative to the dimensions the headrest, said fabric including internal bands of resilient material having a greater modulus of elasticity than that of said fabric, said bands secured within said fabric proximally against each of said lines of dependency between said center surface and said lateral extensions of said headrest.

It is an object of the invention to provide for proper sanitation of otherwise unprotected headrests of public seats and seats in public carriers.

It is another object to reduce the transmissibility of skin and other medical conditions that can be transmitted by human contact.

The invention addresses a long standing need that all prior efforts have failed to adequately resolve, including the impact a cover's cost per unit, the need to make covers easy and quick to install and remove, the need to reduce the amount of handling by service personnel, the need to make covers available to individual seat occupants, the need for covers in all public seating; the need to make covers widely available; and the need for making covers available in compact and convenient packaging.

An outstanding aspect of the present invention is that the general public only be provided with an alternative for protecting themselves from potential contamination without relying on commercial carriers, cinema theaters or others to do so for them.

### BRIEF DESCRIPTION OF THE DRAWINGS

FIG. 1 is a perspective view of a conventional three part headrest.

FIG. 2 is a view similar to FIG. 1, however showing extensions of the headrest moved toward the centerline of the seat.

FIG. 3 is an external view of the novel headrest cover.

FIG. 4 is a rear view of the headrest cover.

FIG. 5 is a view of prior art showing a headrest cover.

### DETAILED DESCRIPTION OF THE INVENTION

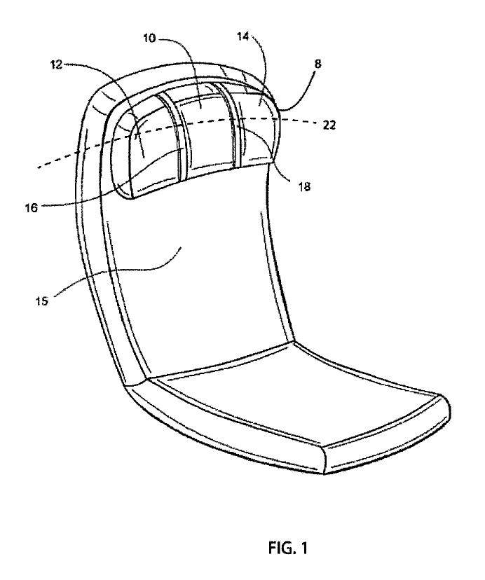

Shown in FIG. 1 is a three-part headrest 8 of an airplane seat 15, the headrest including a central section 10 and left and right lateral extensions 12 and 14, each of which integrally connect to the central section by respective lines of dependency 16 and 18.

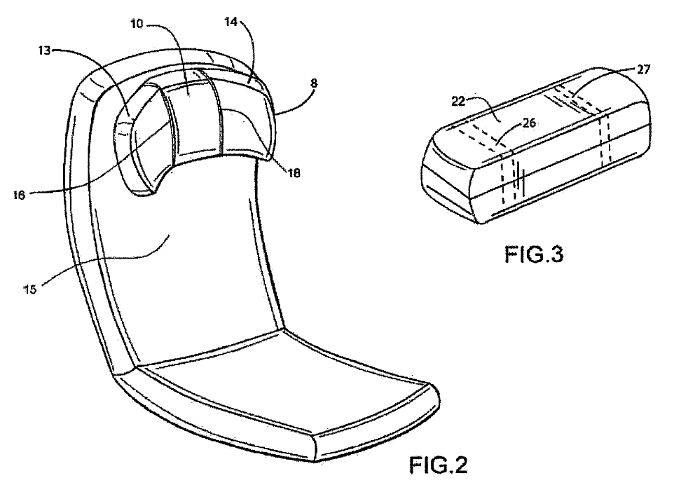

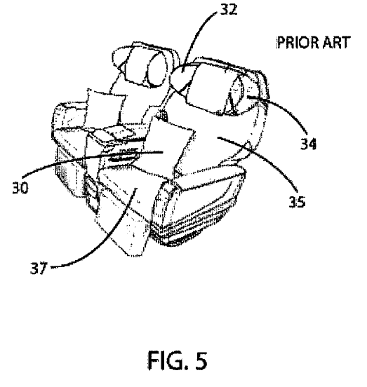

As may be seen in FIG. 2, either or both extensions 12 and 14 may be selectably bent in the direction of a vertical centerline of seat 15 until a position of comfort to the passenger is attained. Headrests of this type are common and have been in use since at least 2006. However, the provision of a suitable cover for headrest of this type has proven elusive, as may be seen in Resendez, US. Pat. No. 7,726,735, FIG. 2-B thereon, in which a less than optimal solution to this issue is suggested. See FIG. 5 marked “Prior Art.” That is, the extension regions of the headrest of Resendez are neither completely nor securely coverable. As such, a problem with headrests of this type is that unless the cover fully and closely envelops the lines of dependency between the lateral extensions and the center panel, the entire cover cannot securely and flushly engage the complete headrest and, particularly, the lateral extensions thereof.

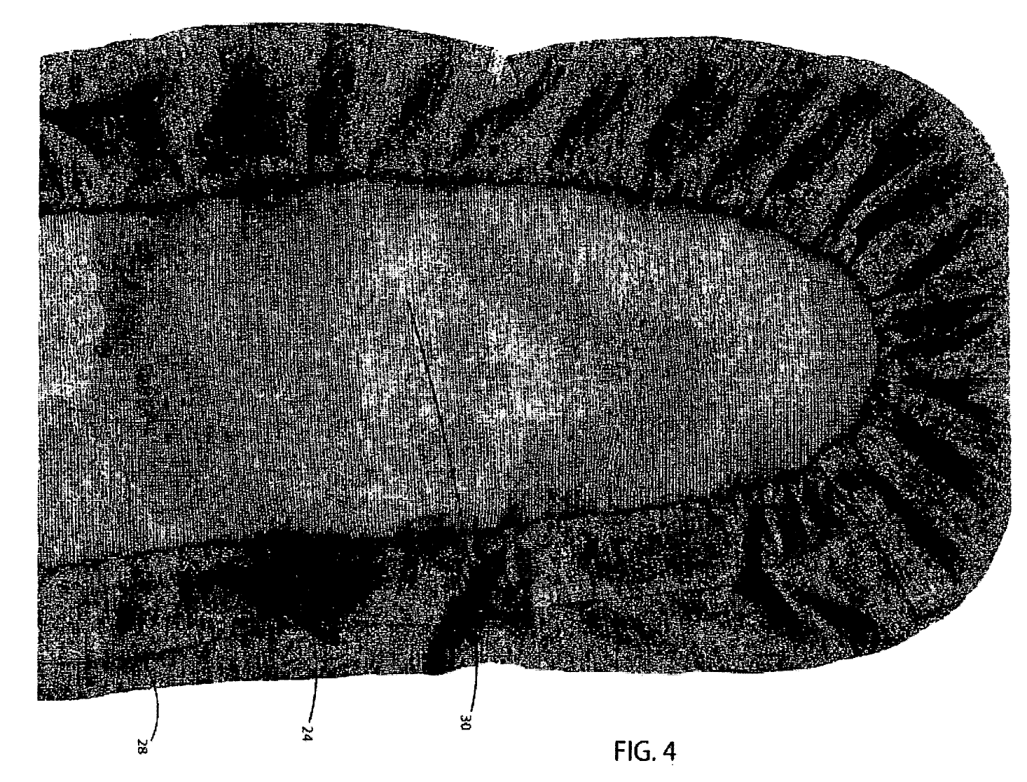

The instant invention addresses this problem by providing an initially solid rectangular cover 22 (see FIGS. 3 and 4) formed of a selectable breathable, stretchable, moisture absorbable fabric, such as a Terry or Jersey-knit fabric having therein a small percent of lycra-spandex, e.g., 5 to 10% or an equivalent elastomer thereof.

A polyester or polypropylene fabric may be employed at a lower cost, if breathability or skin irritation is a lesser concern. However, cotton-based fabrics lend themselves to comfort and the use of printing of more complex fonts and pleasing patterns on the surface thereof without the use of potentially irritating inks.

As may be seen in FIG. 4, it is generally advantageous to include a hem 32 that encloses a drawstring 20 near the periphery of the cover 22 (see FIG. 4) to assure that the cover is initially positioned completely over the opened headrest, shown in FIG. 1. Therein, the inclusion of a cord lock 24 permits adjustments of size of the cover to that of the particular headrest 8.

Secured to back surface 20 of the cover 22 is a pair of resilient bands 26 and 28 that are positioned oppositely to the said lines of dependency 16 and 18, above described. Said bands are particularly selected according to their modulus of elasticity to tightly engage each of the lines of dependency such that the headrest cover drawstring 20, when opened by lock 24, will remain firmly engaged against all surfaces including extensions 12 and 14.

As may be noted in FIG. 4, each band 26/28 must be firmly secured across back surface 22 of the cover, including the underside of cover hem 32 at regions 34 shown in phantom in FIG. 4. As such, hem 32 plays an important role in this invention since it encloses both drawstring 20 and regions 34 of the bands 26/28, all of which, together with lock 24, are essential to a firm and stable securement of the cover to the headrest when its extensions 12/14 are utilized, thus resolving the issue of such securement that exists in the prior art. (See FIG. 5).

As such, the present headrest, which may be either disposable or washed, should the passenger wishes, will fully cover a laterally adjustable headrest regardless of the degree of closure toward the seat centerline of the lateral extension thereon.

Prior to use of the present headrest cover, the uncovered headrest 8 and entire seat 15 should be swathed with an antibacterial product such as Wet Wipes.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. A cover for a variable geometry vehicle headrest having a geometry including a center surface and integral left and right lateral extensions, each of said lateral extensions defining planes of angulation relative to said center surface along respective lines of dependency between said center surface and each respective lateral extension, the cover comprising:
a stretchable, breathable moisture-absorbent fabric enveloping said headrest and formed in proportion to dimensions smaller that said headrest but within a range of stretchability of the cover relative to the dimensions the headrest, said fabric including internal bands of resilient material having a greater modulus of elasticity than that of said fabric, said bands secured within said fabric proximally against each of said lines of dependency between said center surface and said lateral extensions of said headrest.

2. The headrest cover as recited in claim 1, said range of stretchability of said fabric defines multi-directional stretchability thereof.

3. The headrest cover as recited in claim 2, in which:
the range of elasticity of said internal resilient-bands enables firm engagement an entire cover to each of said lines of dependency.

4. The cover as recited in claim 3, in which said fabric includes a slightly stretchable Terry knit fabric formed substantially of cotton.

5. The cover as recited in claim 3, in which said fabric includes a slightly stretchable Jersey knit fabric formed substantially of cotton.
